(19) United States
(12) Patent Application Publication
(10) Pub. No.: US 2018/0035110 A1
(43) Pub. Date: Feb. 1, 2018

(54) Cable Box Rack for Testing Stations

(71) Applicants: Jorge Rivera, Hermosa Beach, CA (US); Michael Steven O'Brien, Hermosa Beach, CA (US)

(72) Inventors: Jorge Rivera, Hermosa Beach, CA (US); Michael Steven O'Brien, Hermosa Beach, CA (US)

(21) Appl. No.: 15/225,604

(22) Filed: Aug. 1, 2016

(51) Int. Cl. H04N 17/04; A47B 81/00; A47B 97/00; H04N 5/63

(52) U.S. Cl. CPC H04N 17/04; H04N 5/63; A47B 81/00; A47B 97/00; A47B 2097/003

(57) ABSTRACT

A testing rack for infrared cable boxes has a bottom panel and a series of opposing top arms. The bottom panel and the top arms are spaced apart by a substantially planar back panel, and each of the top arms is configured to deflect relative to the back panel to allow a cable box to be installed and removed. An emitter bar on the back panel includes a channel and a series of slots, each corresponding to one of the top arms. The slots are each located next to an IR emitter port formed in the back panel, and are sized to accommodate an IR emitter cable. The channel is sized to hold a plurality of IR emitters such that each IR emitter is visible to a cable box through an IR emitter port with the IR emitter cable extending through a slot.

### FIELD OF THE INVENTION

The present invention generally relates to storage for electronic tuning devices. More specifically, the present invention relates to a rack for holding and testing multiple television converter boxes.

### RELATED ART

Cable boxes and similar devices for converting and transporting cable channel data to a television are known in the art. For selecting among various channels, cable boxes rely on an infrared receiver and remote control. Cable boxes are typically owned by a cable provider and thus are not sold, but leased to end users. When a cable subscription terminates, the cable box is returned to the cable provider by the end user, tested and re-leased to a new user. Since cable providers frequently serve many customers over a large geographical area, account turnover requires constant testing (and repair if necessary) of cable boxes for new accounts.

When testing cable boxes, an IR emitter is placed in front of a cable box and connected to a controller that issues a series of commands, such as powering on the cable box, changing channels, etc., to make sure the cable box is fully functional. The testing process in the current art requires an individual emitter to be paired with an individual cable box, fully testing the cable box, and then moving on to the next pairing. This process is time consuming and requires considerable labor in repeatedly assembling and disassembling an emitter and cable box for each cable box needing testing.

Hence, what is needed is an apparatus that provides for simultaneous IR testing of multiple cable boxes without the limitations of existing techniques.

### SUMMARY

A testing rack for cable boxes, including cable boxes having IR receivers includes a bottom panel and a plurality of top arms. The bottom panel and the top arms are spaced apart by a substantially planar back panel. Each of the top arms is configured to deflect, individually, relative to the back panel, thereby allowing a cable box to be installed therein. An emitter bar is disposed on the back panel. The emitter bar includes a plurality of first slots that correspond to the top arms. The emitter bar also has a channel. The plurality of first slots on the emitter bar are disposed individually adjacent a plurality of IR emitter ports, which are formed in the back panel. Each of the plurality of first slots sized to accommodate an IR emitter cable. The channel is sized to hold a plurality of IR emitters such that each IR emitter is visible to a cable box through an IR emitter port.

The bottom panel preferably includes a bottom edge guard for retaining cable boxes installed in the testing rack. In addition to the edge guard, the bottom panel preferably also includes cable box dividers configured to align installed cable boxes with the top arms when installed in the testing rack. Each of the plurality of top arms preferably includes a tab for deflecting the top arm relative to the back panel, thereby facilitating installation of a cable box. Each of the top arms also preferably includes a power control access port. The power control access ports each correspond to a power control on a cable box installed in the testing rack.

The back panel preferably includes anchor points corresponding to a standard nineteen inch studio rack. The back panel also includes cable ports sized to accommodate a plurality of emitter cables extending through the back panel. Importantly, the back panel also preferably includes a plurality of power indicator windows corresponding to power indicators on each of the cable boxes installed in the testing rack. A series of second slots may be formed in the back panel between each of the top arms to allow easier deflection of a top arm relative to the back panel. In one embodiment, the bottom panel and the plurality of top arms comprise vent ports adjacent vents of a cable box installed in the testing rack, to allow adequate cooling of the cable box.

The testing rack may also be characterized as having a substantially planar back panel with a first side and a second side. A series of IR emitter ports are disposed in the back panel and an emitter bar is disposed on the first side. The emitter bar includes a plurality of first slots, each of the plurality of first slots sized to accommodate an IR emitter cable, and each of the plurality of first slots is disposed individually adjacent a plurality of IR emitter ports formed in the back panel. A bottom panel and a plurality of top arms are disposed on the second side for holding cable boxes. Each of the top arms is configured to individually deflect relative to the back panel for installing and removing a cable box, and the channel is sized to hold a plurality of IR emitters such that each IR emitter is visible to a cable box through an IR emitter port for testing.

### BRIEF DESCRIPTION OF THE FIGURES

FIG. 1 illustrates a perspective view of a cable box testing rack;

FIG. 2 illustrates a rear view of the testing rack;

FIG. 3 illustrates a rear perspective view of the testing rack with an emitter housing removed;

FIG. 4 illustrates a front view of the testing rack with a cable box installed therein;

FIG. 5 illustrates a rear view of the testing rack with a cable box installed therein;

FIG. 6 illustrates a bottom perspective view of the testing rack with a cable box installed therein; and

FIG. 7 illustrates a rear view of the testing rack filled with cable boxes and installed in a standard electronics equipment enclosure.

### DETAILED DESCRIPTION

The following description is presented to enable any person skilled in the art to make and use the invention, and is provided n the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

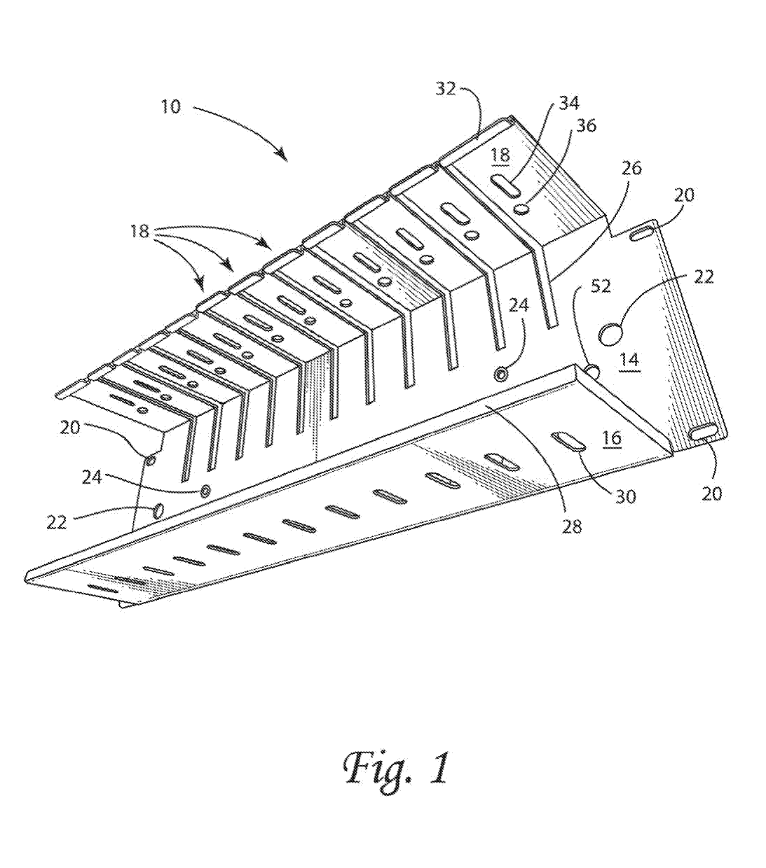

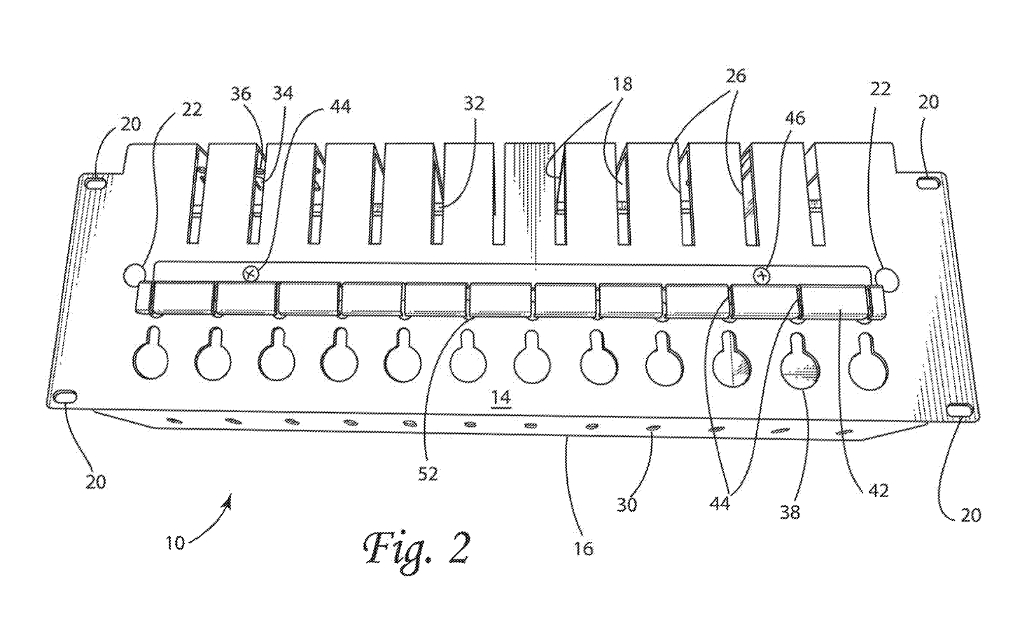

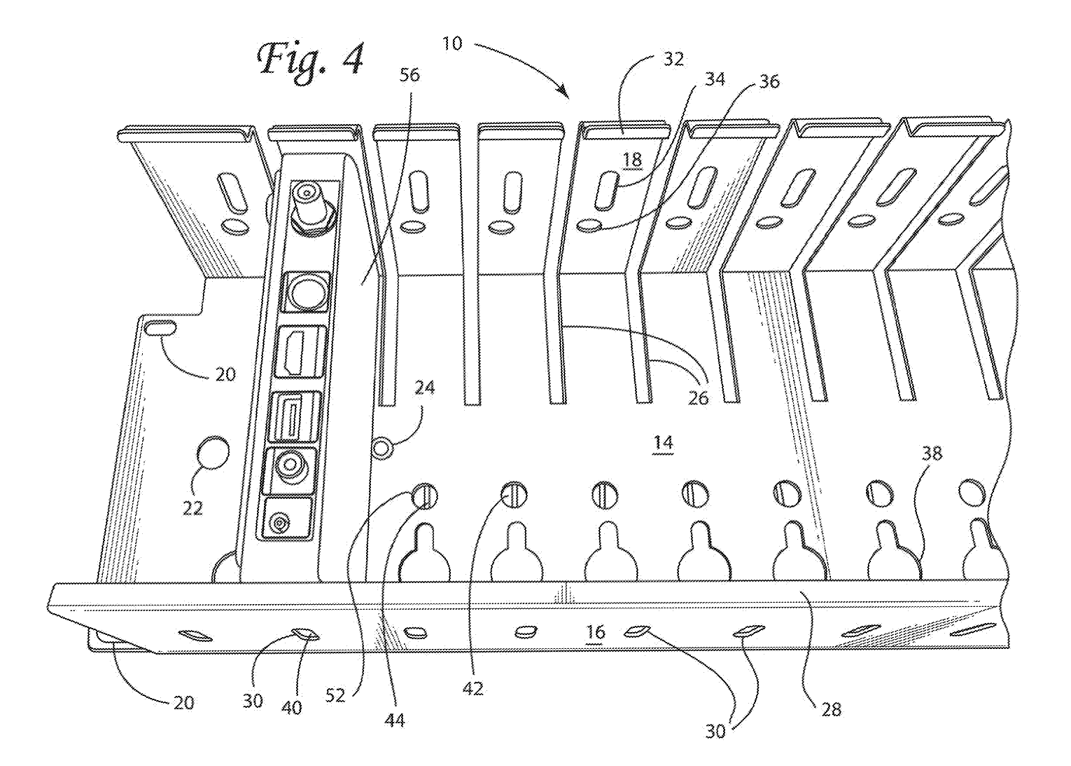

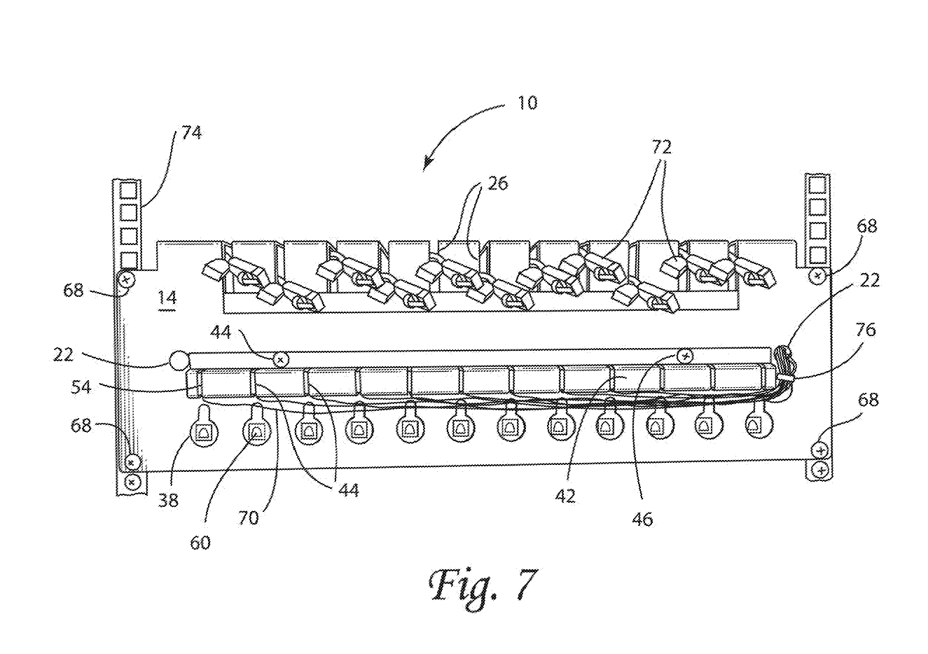

Referring to FIG. 1, a cable box rack (rack) 10 for cable box testing stations (not shown) includes a back panel 14, a bottom panel 16, and a series of top arms 18 for individually holding cable boxes 56 (FIGS. 4-6). The back panel 14 is preferably sized for installation in a standard nineteen inch electronics rack 74 (FIG. 7), and includes a series of rack anchor points 20 for installation. In the illustrated embodiment, four anchor points 20 are employed. In addition to the anchor points 20, the back panel 14 includes cable ports 22, through which a collection of emitter cables 70 (FIG. 7) may be passed. The back panel 14 also has a series of emitter ports 52 corresponding to each of the top arms 18, and emitter bar anchorages 24 for fastening an emitter bar 42 (FIGS. 2-3, 5 and 7), discussed below. The back panel 14 is also characterized by a series of slots 26 between the top arms 18, which render the top arms 18 individually flexible, so that each top arm 18 can deflect under pressure, thereby allowing cable boxes 56 to be selectively installed and removed from the rack 10.

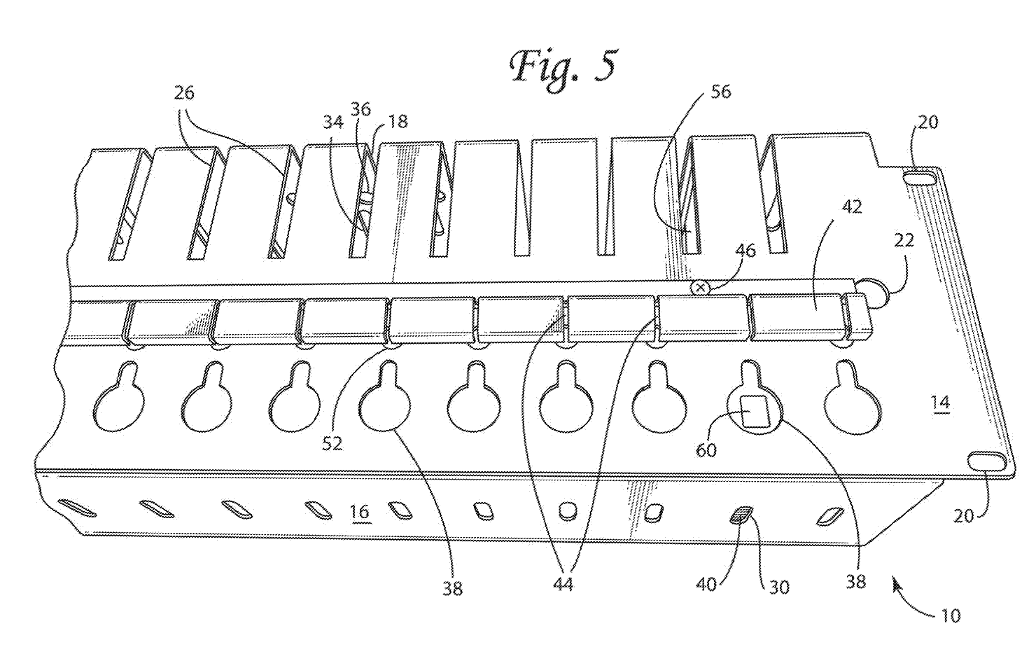

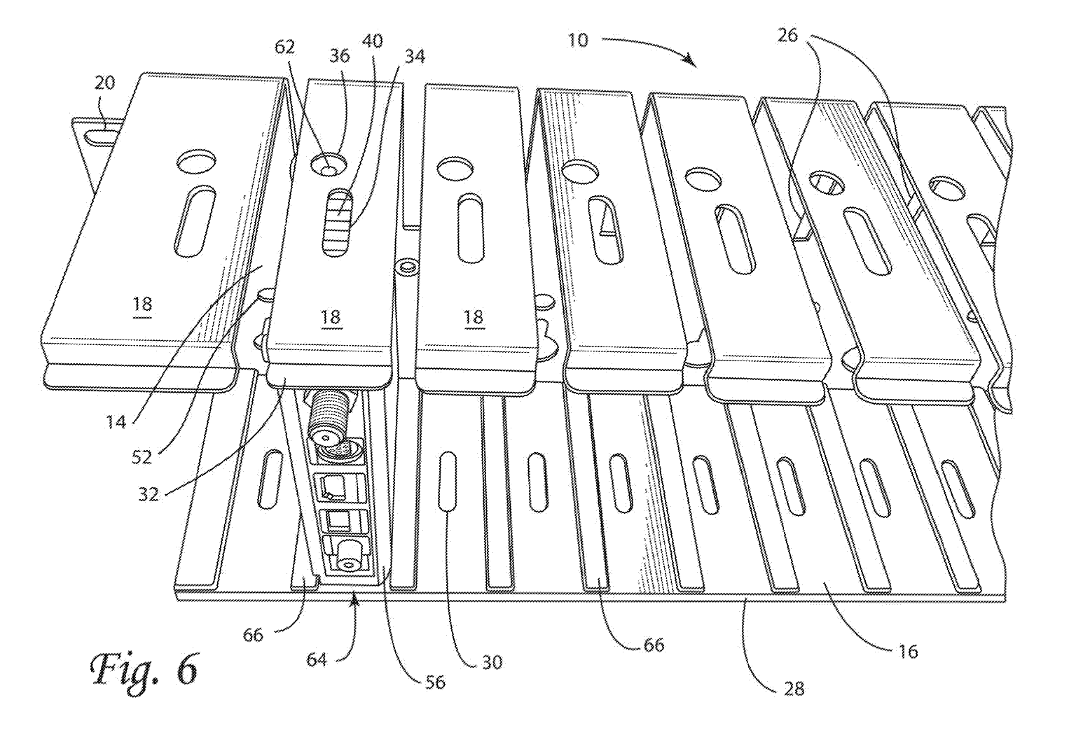

Still referring to FIG. 1, the bottom panel 16 includes a bottom panel edge guard 28 to prevent installed cable boxes 56 from moving relative to the bottom panel 16, and bottom vent ports 30 corresponding vents 40 (FIG. 5) on a cable box 56 for dissipating heat. The top arms 18 each have a tab 32 for manipulating a top arm 18 when installing and removing a cable box 56 from the rack 10. The tabs 32 are set slightly off plane from the top arms 18, thereby allowing the tabs 32 to securely hold each cable box 56. The top arms 18 include top vent ports 34 corresponding to vents 40 (FIG. 6) on the cable boxes 56, similar to the bottom vent ports 30, to allow cross ventilation through the cable boxes 56 when installed. A power control access 36 on each top arm 18 allows user access to each installed cable box 56 for powering it on and off. Although the terms ‘top’ arm 18 and ‘bottom’ panel 16 are used herein, it is to be understood that the rack 10 may be installed inverted from the illustrated configuration according to preference.

Referring to FIG. 2, the back of the rack 10 is shown as it would be installed, preferably facing the inside of the electronics rack 74. In this view the emitter bar 42 is shown installed on the back panel 14. The emitter bar 42 holds the emitters 54 (FIG. 7), allowing them to communicate with installed cable boxes 56. The emitter bar 42 is fastened to the back panel 14 using emitter bar fasteners 46 extending through the emitter bar anchorages 24 on the back panel 14. A series of emitter cable slots 44 are formed in the emitter bar 42. Each emitter cable slot 44 accepts an individual emitter cable 70, thereby holding an emitter 54 adjacent an emitter port 52. The emitter cable slots 44 and emitter ports 52 align with an IR (infra-red) signal receiver (not shown) on each cable box 56.

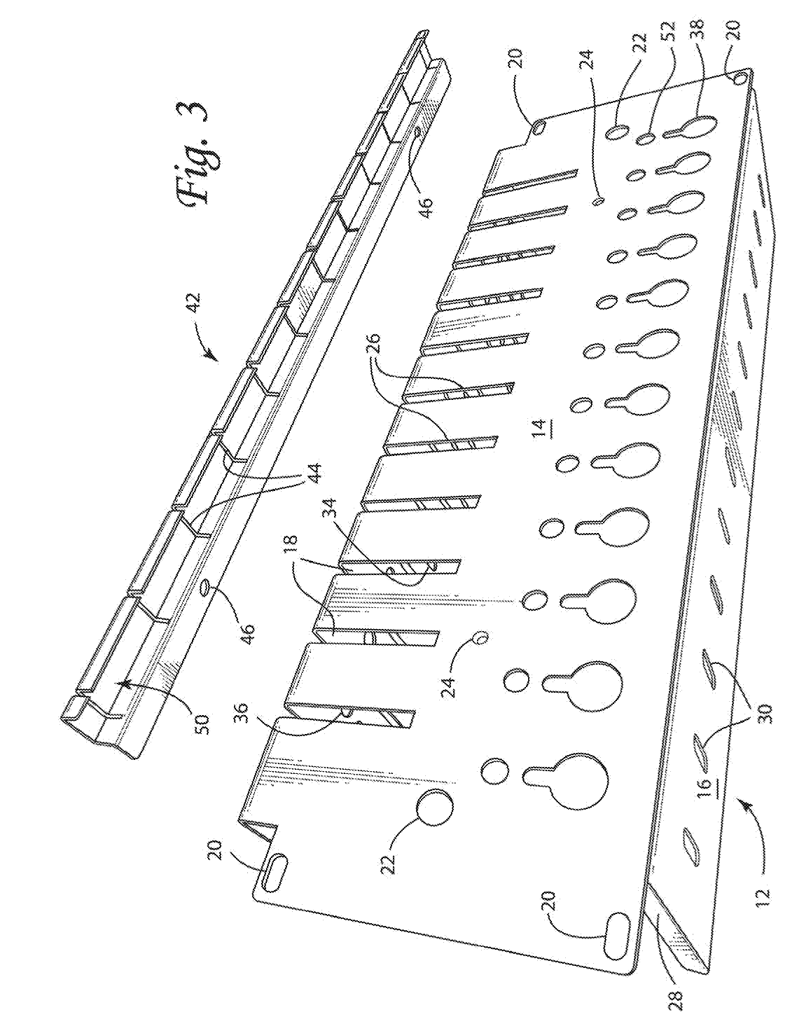

Referring to FIG. 3, the emitter bar 42 is shown removed from the back panel 14. The emitter bar 42 includes a lengthwise channel 50 for accommodating the emitters 54. Since the emitter 54 will not fit through the emitter cable slots 44, users may place an emitter 54 in the lengthwise channel 50 when the emitter bar 42 is removed, and pass its emitter cable 70 through the emitter cable slot 44. Once the required number of emitters 54 are in place, the emitter bar 42 can be reinstalled on the back panel 14. The substantially enclosed nature of the channel 50 also helps prevent other light sources from reaching IR receivers on the cable boxes 56, thereby avoiding unwanted interference from ambient light, and in particular light approaching the IR spectrum. The individual emitter ports 52 prevent IR signal from adjacent emitters from reaching a cable box. The emitter ports 52 are also sized complimentary to a cable box 56 IR receiver to avoid light pollution from external sources.

Referring to FIG. 4, a cable box 56 is shown installed in the rack 10. Among the anticipated uses of the rack 10, any number of cable boxes 56 may be installed according to preference or need. With a cable box 56 held in place by the bottom panel 16 and top arm 18, and an emitter 54 in the channel 50 of the emitter bar 42, the emitter 54 is held directly in front of the cable box 56 IR receiver. A cable box 56 vent 40 is shown appearing in the bottom vent port 30, preventing heat build-up. The rack 10 leaves the cable box input/outputs 64 exposed for ease of access when connecting various signal connectors (not shown) from a testing station to a cable box 56. In the illustrated embodiment, conventional input/outputs 64, including coaxial, HDMI, and USB receptacles are shown.

Referring to FIG. 5, the rack 10 is shown with a cable box 56 installed. The cable box 56 is held against the back panel 14, confined by the bottom panel 16 and one of the top arms 18. The vents 40 are aligned with a bottom vent port 30 and top vent port 34, preventing the cable box 56 from overheating. The power indicator 60 of the cable box 56 is shown appearing through a power indicator window 38, which enables a user testing the cable box 56 to ensure that the cable box 56 is powered before attempting to control it with an emitter 54.

Referring to FIG. 6, the cable box 56 is shown installed in the rack 10 and held in place by a top arm 18 and the bottom panel 16. The cable box 56 vent 40 appears in a top vent port 34 adjacent the power on/off control 62 appearing through the power control access 36 on the top arm 18. Also shown in this view is a series of cable box dividers 66 on the bottom panel 16. The cable box dividers 66 prevent the cable box 56 from moving laterally when held in the rack 10 in the event the cable box 56 is inadvertently bumped or otherwise disturbed when installed.

FIG. 7 shows the rack 10 installed in a larger electronics rack 74 using second fasteners 68 with a full complement of cable boxes 56 installed therein. Emitters 54 have been installed in the channel 50 with each emitter cable 70 extending through an emitter cable slot 44 for controlling the cable boxes 56. The emitter cables 70 may be grouped and held by a cable tie 76 near the cable port 22 through which they pass to present an organized and tidy appearance. Input/output cables 72 have been temporarily placed in the slots 26 between the top arms 18 adjacent their respective cable boxes 56. The power indicator 60 of each cable box 56 can be seen through each of the power indicator windows 38 on the back panel 14. Once the input/output cables 72 are connected to their respective cable boxes 56, the cable boxes 56 may be easily and quickly tested for defects.

The features of the cable box rack 10 having been shown and described, its method of operation will now be discussed.

For initial setup, the rack 10 is installed in an electronics rack 74 with associated testing equipment and input/output cables 72, including a customary nineteen inch electronics rack 74. The emitter bar 42 is then removed using the first fasteners 46 and a series of emitters 54 are installed in the channel 50 with the emitter cable 70 of each emitter 54 running through an emitter cable slot 44. The emitter cables 70 are optionally tied together with a cable tie 76 and run through a cable port 22, to be connected to the testing equipment for receiving and transmitting signal.

To test one or more cable boxes 56, a preferred number of individual cable boxes 56 are installed in the rack 10. Each cable box 56 is installed by lifting up on the tab 32 of a top arm 18, thereby causing it to deflect. Each cable box 56 is seated in the bottom panel 16 between cable box dividers 66, or if on the end, between a cable box divider 66 and the bottom panel edge guard 28, and slid against the back panel 14. As a cable box 56 reaches the back panel 14 it clears the tab 32 and the top arm 18 closes down on it. With each cable box 56 in an installed position, the vents 58 on the cable box 56 are aligned with the bottom vent port 30 and top vent port 34, the power button 62 is aligned with the power control access 36, the IR receiver is proximal its respective emitter 54 through an emitter port 52, the power indicator 60 is visible through its respective power indicator window 38, and the cable box input/outputs 64 are easily accessible for connection with the input/output cables 72.

Once the input/output cables 72 are connected to the appropriate cable boxes 56, and the cable boxes 56 powered on, typically by depressing the power buttons 62 in the power control accesses 36, a user may ensure that all the cable boxes 56 have power by inspecting the power indicator windows 38 on the back panel 14. If all of the cable boxes 56 are powered and plugged in, testing equipment can be activated to interface with and control the cable boxes 56. The testing equipment transmits and detects control information including signal strength, channel selection activity, etc.

After the cable boxes 56 have been tested and any faulty boxes identified, they may be disconnected, removed, and placed into service or sent for repair as appropriate. To remove the cable boxes 56, the input/output cables 72 are first disconnected. Then the tab 32 of each top arm 18 is deflected enough to allow a cable box 56 held therein to clear the top arm 18 and slide away from the back panel 14 and out of the rack 10. The rack 10 can be left installed in the electronics rack 74 for testing additional cable boxes 56, or removed and transported to another similar location for testing.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A testing rack for cable boxes having IR receivers, the testing rack comprising:
a bottom panel and a plurality of top arms, the bottom panel and the top arms spaced apart by a substantially planar back panel;
each of the top arms configured to individually deflect relative to the back panel;
an emitter bar disposed on the back panel, the emitter bar comprising a plurality of first slots corresponding to the top arms and further comprising a channel;
each of the plurality of first slots disposed individually adjacent a plurality of IR emitter ports, the IR emitter ports formed in the back panel;
each of the plurality of first slots sized to accommodate an IR emitter cable; and
wherein the channel sized to hold a plurality of IR emitters such that each IR emitter is visible to a cable box through an IR emitter port.

2. The testing rack of claim 1 wherein the bottom panel comprises a bottom edge guard for retaining cable boxes installed in the testing rack.

3. The testing rack of claim 1 wherein the bottom panel comprises cable box dividers configured to align the cable boxes with the top arms installed in the testing rack.

4. The testing rack of claim 1 wherein each of the plurality of top arms comprises a tab for deflecting relative to the back panel.

5. The testing rack of claim 1 wherein each of the plurality of top arms comprises a power control access corresponding to a power control on a cable box installed in the testing rack.

6. The testing rack of claim 1 wherein the back panel comprises anchor points corresponding to a standard nineteen inch studio rack.

7. The testing rack of claim 1 wherein the back panel comprises cable ports sized to accommodate a plurality of emitter cables.

8. The testing rack of claim 1 wherein the back panel comprises a plurality of power indicator windows corresponding to power indicators on each of the cable boxes installed in the testing rack.

9. The testing rack of claim 1 further comprising a plurality of second slots formed in the back panel between each of the top arms to allow easier deflection of a top arm relative to the back panel.

10. The testing rack of claim 1 wherein the bottom panel and the plurality of top arms comprise vent ports adjacent vents of a cable box installed in the testing rack.

11. A testing rack for cable boxes having IR receivers, the testing rack comprising:
a substantially planar back panel having a first side and a second side;
a series of IR emitter ports disposed in the back panel;
an emitter bar disposed on the first side, the emitter bar comprising a plurality of first slots, each of the plurality of first slots sized to accommodate an IR emitter cable;
each of the plurality of first slots disposed individually adjacent a plurality of IR emitter ports, the IR emitter ports formed in the back panel;
a bottom panel and a plurality of top arms disposed on the second side;
each of the top arms configured to individually deflect relative to the back panel;
wherein the channel sized to hold a plurality of IR emitters such that each IR emitter is visible to a cable box through an IR emitter port.

12. The testing rack of claim 11 wherein the bottom panel comprises a bottom edge guard for retaining cable boxes when installed in the testing rack.

13. The testing rack of claim 11 wherein the bottom panel comprises cable box dividers configured to align the cable boxes with the top arms when installed in the testing rack.

14. The testing rack of claim 11 wherein each of the plurality of top arms comprises a tab for deflecting relative to the back panel.

15. The testing rack of claim 11 wherein each of the plurality of top arms comprises a power control access corresponding to a power control on a cable box when installed in the testing rack.

16. The testing rack of claim 11 wherein the back panel comprises anchor points corresponding to a standard nineteen inch studio rack.

17. The testing rack of claim 11 wherein the back panel comprises cable ports sized to accommodate a plurality of emitter cables.

18. The testing rack of claim 11 wherein the back panel comprises a plurality of power indicator windows corresponding to power indicators on each of the cable boxes when installed in the testing rack.

19. The testing rack of claim 11 further comprising a plurality of second slots formed in the back panel between each of the top arms to allow easier deflection of a top arm relative to the back panel.

20. The testing rack of claim 11 wherein the bottom panel and the plurality of top arms comprise vent ports adjacent vents of a cable box when installed in the testing rack.
